(19) United States
(12) Patent Application Publication
(10) Pub. No.: US 2025/0013403 A1
(43) Pub. Date: Jan. 9, 2025

(54) INFORMATION PROCESSING APPARATUS, CONTROL METHOD, AND STORAGE MEDIUM

(71) Applicant: CANON KABUSHIKI KAISHA, Tokyo (JP)

(72) Inventor: YASUHIRO HOSODA, Kanagawa (JP)

(21) Appl. No.: 18/760,927

(22) Filed: Jul. 1, 2024

(30) Foreign Application Priority Data
Jul. 5, 2023 (JP) 2023-110475

(51) Int. Cl. G06F 3/12; G06F 21/36

(52) U.S. Cl. CPC G06F 3/1238; G06F 3/1203; G06F 3/1222; G06F 21/36

(57) ABSTRACT

In response to a pattern generation request, a new pattern is generated automatically, and notification to the user's e-mail address is performed. Control is performed to generate a pattern that meets predetermined conditions and not to generate a pattern that is excessively complex.

### BACKGROUND OF THE DISCLOSURE

### Field of the Disclosure

Some embodiments of the present disclosure generally relate to an information processing apparatus that performs authentication processing, a control method thereof, and a non-transitory computer-readable storage medium.

### Description of the Related Art

These days, there are a wide variety of authentication methods on devices such as multifunction printers. As one of such a variety of authentication methods, the following authentication method (pattern authentication) is known as disclosed in Japanese Patent Laid-Open No. 2016-170721. A user runs the user's fingertip on a touch-sensitive panel to draw a figure. The pattern of the figure (trajectory) drawn by the finger stroke is compared with a pre-registered pattern to check whether the two patterns match or not.

### SUMMARY OF THE DISCLOSURE

An information processing apparatus according to a certain embodiment of the present disclosure is as follows. The information processing apparatus is configured to offer at least a print function through execution of authentication in log-in operation. The information processing apparatus includes one or more memories that store a set of instructions, and one or more processors that execute the instructions. The instructions, when executed, cause the information processing apparatus to perform operations. The operations include receiving an instruction, generating a pattern, storing the generated pattern, and performing notification. The instruction received is an instruction for generating a pattern to be used in pattern authentication. The pattern authentication is one of ways of the authentication in the log-in operation. In a case of a failure in the log-in operation, the generating of the pattern is redone, and, in the notification, information regarding a pattern generated again by redoing the generating is notified to a notification address corresponding to a user registered in the information processing apparatus.

Further features of the present disclosure will become apparent from the following description of exemplary embodiments with reference to the attached drawings.

### BRIEF DESCRIPTION OF THE DRAWINGS

FIG. 1 is a diagram illustrating a system configuration.

FIG. 2 is a diagram illustrating a hardware configuration of an MFP.

FIG. 3 is a diagram illustrating a software configuration of the MFP.

FIG. 4 is a diagram illustrating a user interface of user authentication settings.

FIG. 5 is a diagram illustrating a user interface for editing user account information.

FIG. 6 is a diagram illustrating a menu and user interfaces of log-in screens.

FIG. 7 is a diagram illustrating an operation flow when pattern registration is performed, and screen transition.

FIG. 8 is a diagram illustrating an operation flow when pattern authentication is used, and screen transition.

FIG. 9 is a flowchart illustrating operations for pattern generation and notification.

FIG. 10 is a diagram illustrating examples of e-mail for notification of a new pattern.

FIG. 11 is a diagram of tables showing examples of a static next-point candidate list.

FIG. 12 is a diagram of tables showing dot continuity.

FIG. 13 is a diagram of vector tables each of which contains a move group of the same direction from the starting point of the move to the ending point of the move.

FIG. 14 is a diagram illustrating a series of processes for pattern generation according to a first pattern generation example.

FIG. 15 is a diagram illustrating a series of processes for pattern generation according to a second pattern generation example.

FIG. 16 is a diagram illustrating pattern examples.

### DESCRIPTION OF THE EMBODIMENTS

In pattern authentication according to related art, a user cannot log in when the user cannot remember the pattern that was registered. Japanese Patent Laid-Open No. 2016-170721 is also silent about what to do when the user cannot remember the pattern that was registered.

In a case of a shared device for which there is an administrator, for example, a multifunction printer, which is an information processing apparatus having a print function, the user who forgot their registered pattern is able to contact the administrator of the multifunction printer and ask him/her to reset this pattern or ask him/her to delete the user's account and perform account registration again as a possible solution. In this case, it is burdensome for the user to contact the administrator and for the administrator to implement the requested operations.

The present disclosure proposes an information processing apparatus that enables the user who forgot the registered pattern for pattern authentication to receive pattern reissuance through the user's own operations and thus to make it available for use again.

With reference to the accompanying drawings, embodiments for implementation of the present disclosure will now be described.

### First Embodiment

An embodiment of the present disclosure will now be described while taking, as an example of an information processing apparatus to which the disclosed technique is applied, an MFP (multifunction peripheral) having a print function and a read function for copying, printing, scanning, and the like. The information processing apparatus may be an ink-jet printer. The disclosed technique can be applied to any kind of information processing apparatus as long as it is equipped with a touch-sensitive panel.

### System Configuration

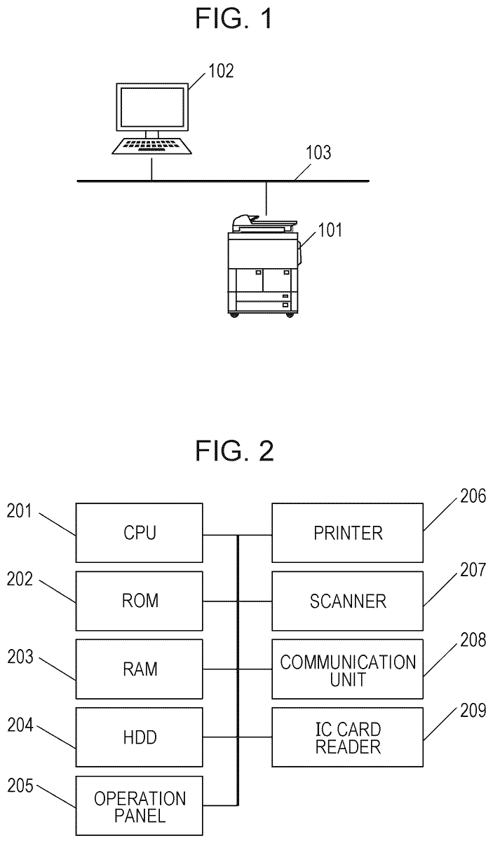

With reference to FIG. 1, a system configuration of the present embodiment will now be described. An MFP 101 is a multifunction peripheral to which the disclosed technique is applied, and is a so-called multifunction printer. The MFP 101 is capable of receiving a print job from a terminal (for example, a PC 102) connected thereto via a network LAN 103.

### Hardware Configuration

FIG. 2 is a simplified diagram of a hardware configuration of the MFP 101. A CPU 201 is a central arithmetic device (processor) that controls the entire operation of the MFP 101. A RAM (random access memory) 203 is a volatile memory configured to provide a work area, and is used as a temporary storage area for loading various control programs stored in a ROM (read-only memory) 202 and an HDD (hard disk drive) 204.

The ROM 202 is a non-volatile memory, and a boot program of the MFP 101 and the like are stored therein. The HDD 204 is a non-volatile hard disk having a larger capacity than that of the RAM 203. Programs for MFP control are stored in the HDD 204. Besides the control programs, an OS (operating system) and application programs are stored in the HDD 204.

When the MFP 101 is activated, the CPU 201 runs the boot program stored in the ROM 202. The boot program is run for reading out programs of the OS (operating system) stored in the HDD 204 and loading them onto the RAM 203. After running the boot program, the CPU 201 runs the programs of the OS having been loaded onto the RAM 203 to control the MFP 101. Data to be used for operations by the control programs are also loaded onto the RAM 203, and the CPU 201 performs reading and writing thereof.

Though it is assumed herein that a single CPU 201 performs each processing in flowcharts to be described later, any other type of configuration may be adopted for the MFP 101. For example, a plurality of CPUs and microprocessors (MPU) may work together to perform each processing in the flowcharts to be described later. A part of the processing to be described later may be performed using a hardware circuit such as an ASIC (application specific integrated circuit), an FPGA (field-programmable gate array), or the like.

An operation panel 205 is a touch-operable display (touch-sensitive panel). A printer 206 is a print engine that prints out print data received from the outside via a communication unit 208 and digital data acquired from a scanner 207. The scanner 207 is a scanning device that reads a document made of paper and puts it into a digital data format.

The communication unit 208 is a network interface for connection to the Internet, an office LAN (local area network), and the like. An IC card reader 209 is a device for reading out information that is to be used for user authentication from an IC card. This unit is needed for implementing IC card authentication. In the present embodiment, a multifunction printer (the MFP 101) having functions of a printer and functions of a scanner is taken as an example; however, the scope of application of the disclosed technique is not limited to a multifunction printer, and the disclosed technique may be applied to any kind of information processing apparatus as long as it includes an operation panel capable of receiving an input of pattern information.

### Software Configuration

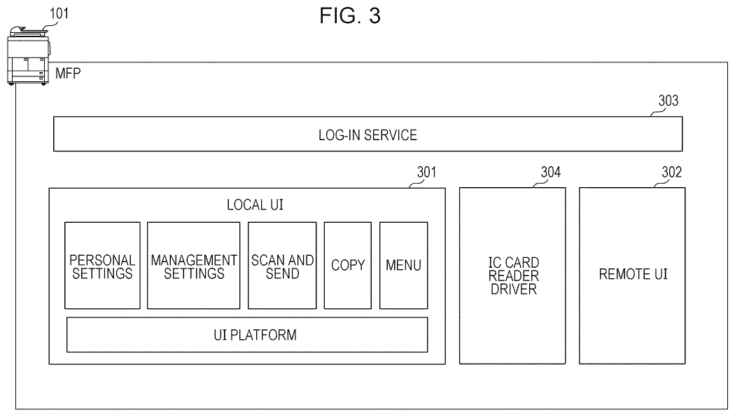

FIG. 3 is a simplified diagram of a software configuration of the MFP 101. A local UI 301 of the MFP 101 provides a user interface displayed on the display of the operation panel 205. The local UI 301 includes a menu via which the user performs function selection, applications, and a UI platform that controls screen transition, and the like. For example, the following applications are included: a copy application for providing a copy function to the user by controlling the printer 206 and the scanner 207, a scan-and-send application for providing, to the user, a function of scanning a document and sending scanned document data by controlling the scanner 207 and the communication unit 208, and the like.

A remote UI 302 has an HTTP (hypertext transfer protocol) server function, and provides a user interface scripted in HTML (hypertext markup language) to the user who makes a remote access. The user is able to access the remote UI 302 by using the web browser of the PC terminal to receive HTMLs and display various screens on the web browser and to make setting changes of the MFP 101 and use the functions thereof by giving user instructions.

A log-in service 303 is a software module that authenticates the user who uses the local UI 301 or the remote UI 302. An IC card reader driver 304 is a driver that controls the IC card reader 209. This driver acquires IC card information from the IC card and furnishes the log-in service 303 with the IC card information.

### User Account

User accounts managed by the log-in service 303 will now be described. The log-in service 303 stores and manages user accounts in a user account table such as one shown in Table 1. The user account table (Table 1) is a database stored in the HDD 204. A database at another node on the network may be used with encryption and tamper protection of the communication pathway and the storage. User names, passwords, card IDs to be used for IC card authentication, patterns, roles, e-mail addresses, and the like are contained in the user account table.

TABLE 1

| User | | | | | e-mail |
|---|---|---|---|---|---|
| name | Password | Card ID | Pattern | Role | Address |
| Admin | ******** | F1EABB15 . . . | [3, 7, | Administrator | admin@ΔΔΔ.com |
| | | | 11, 12, | | |
| | | | 8, 6] | | |
| Alice | ******** | 44E7158E . . . | [1, 10, | Administrator | alice@ΔΔΔ.com |
| | | | 14, 11, | | |
| | | | 7] | | |
| Bob | ******** | 045BB438 . . . | | General user | bob@ΔΔΔ.com |
| Carol | ******** | 19E313B6 . . . | | General user | carol@ΔΔΔ.com |
| Dave | ******** | BDFDB35 . . . | | Limited user | dave@ΔΔΔ.com |

“User name” is identification information for user identification. “Password” is information that is required to be entered when user authentication that is based on the user's identification information and the user's password is performed. “Role” is information that indicates the user's privileges to use the MFP 101. An example of roles and use privileges is shown in a role information table (Table 2) disclosed below. In addition to definitions of roles included in default settings at the time of factory shipment, the MFP 101 may be configured such that the user can create new roles by setting detailed use privileges.

TABLE 2

| Role | Privileges |
|---|---|
| Administrator | Allowed to change settings, Allowed to execute |
| | color printing, Allowed to edit an address |
| | book |
| General user | Not allowed to change settings, Allowed to |
| | execute color printing, Allowed to refer to an |
| | address book |
| Limited user | Not allowed to change settings, Not allowed to |
| | execute color printing, Not allowed to refer |
| | to an address book |

### User Authentication Function

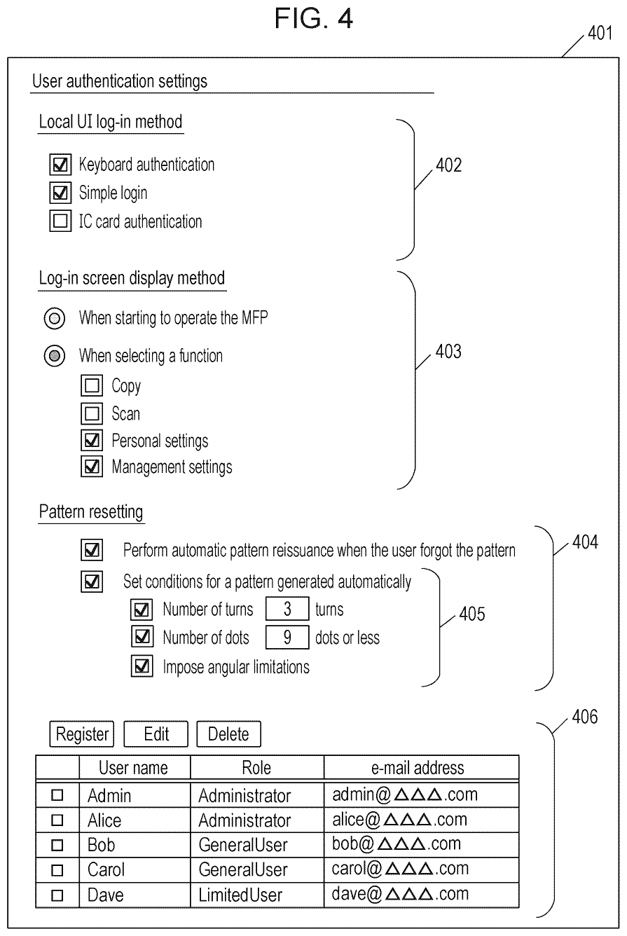

Next, with reference to FIGS. 4, 5, and 6, a user authentication function that the MFP 101 has will now be described. FIG. 4 is a diagram illustrating an example of a UI (user interface) for user authentication settings of the MFP 101 provided by the remote UI 302. Not only the illustrated UI via the remote UI 302 but also a similar UI via the local UI 301 may be provided to the administrator.

A user authentication setting 401 is an example of a remote UI screen for making user authentication settings. Only the user(s) who has the role of Administrator is eligible for an access to this screen. Though not illustrated, the log-in service 303 displays a log-in screen created in HTML to the user who is making an access to the remote UI 302. On the log-in screen for accessing the remote UI 302, user authentication is performed on the basis of the user name and the password, thereby checking whether or not this user is authorized to access the remote UI 302.

A local UI log-in method setting 402 is an example of a user interface for setting a method as to how to perform a local UI login. As choices for the method as to how to perform a local UI login, one or more are selectable from among “keyboard authentication”, “simple login”, and “IC card authentication”. For example, if a plurality of log-in methods has been selected, each user will be required to perform log-in operation twice in order to make the multifunction printer available for use. Each of these log-in methods will now be described.

### Keyboard Authentication

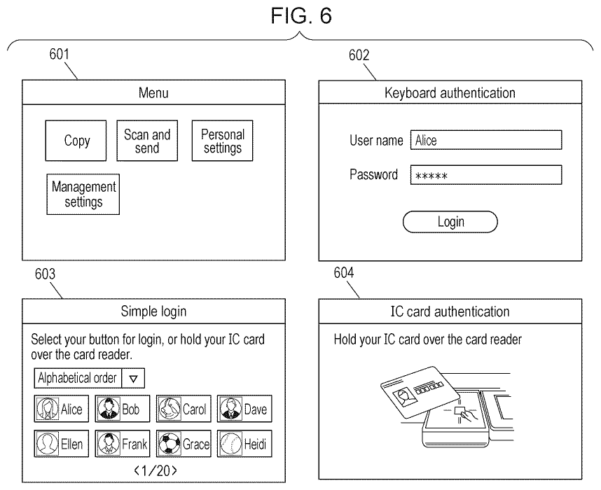

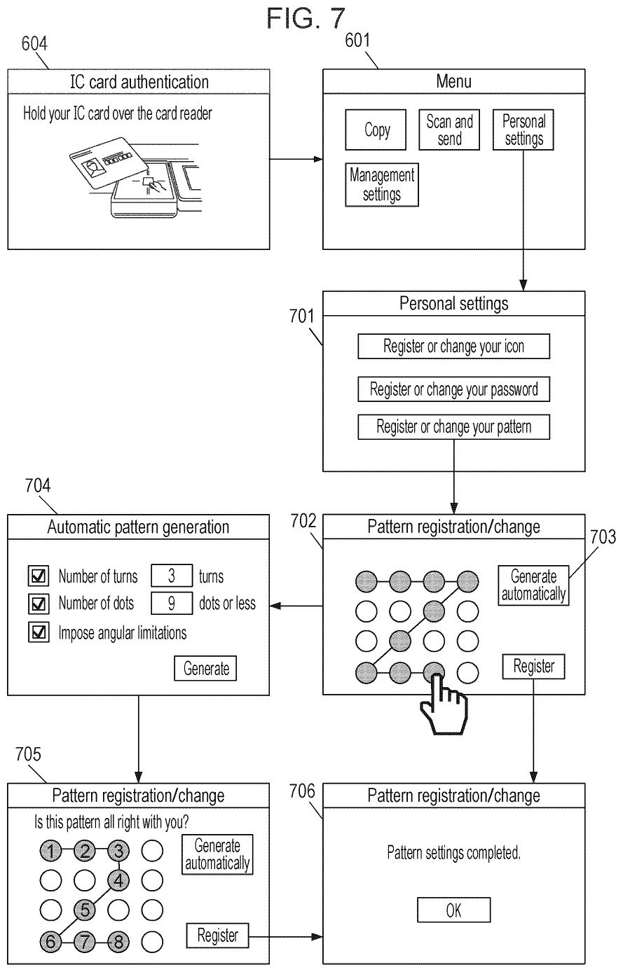

Keyboard authentication provides a method for performing a login by entering a user name and a password on a log-in screen. An example of a log-in screen based on keyboard authentication is illustrated in 602 of FIG. 6. Either hardware keys provided on the MFP 101 or non-illustrated software keys are used when entering the user name and the password.

### Simple Login

Simple login provides a method for performing a login by displaying a pre-registered user button on a log-in screen. An icon image that serves as the user's avatar, and the user name, are displayed on the button. The user is asked to select the button that corresponds to the user's avatar, thereby being allowed to log in to the MFP 101. Simple login can be used in combination with pattern authentication for the purpose of preventing an unauthorized login. In a case where a pattern for pattern authentication has been set by the user, the user is identified on the basis of button selection, and pattern authentication is performed for the identified user. The pattern authentication will be described in detail later.

An example of a log-in screen based on simple login is illustrated in 603 of FIG. 6. In a case where keyboard authentication is ON in addition to simple login, a button for switching display to a keyboard authentication screen is displayed on the simple log-in screen 603. In a case where IC card authentication is ON in addition to simple login, the user is identified by means of the user's ID card held over the IC card reader 209 in a state where the simple log-in screen 603 is displayed, instead of the pressing of the button.

### IC Card Authentication

User authentication is performed using the user's IC card. An example of a log-in screen based on IC card authentication is illustrated in 604 of FIG. 6. In IC card authentication, a card ID is acquired from the user's IC card held over the IC card reader 209, and the user who is associated with the card ID is identified by looking up a user information table, and the identified user is allowed to log in to the MFP 101. IC card authentication can be used in combination with pattern authentication for the purpose of preventing fraudulent use or forgery of the IC card by an unauthorized third party. In a case where the user has set a pattern, after the IC card authentication, pattern authentication is performed for the user identified by the card ID. Combining the former authentication that is based on a factor of possession of the IC card with the latter authentication that is based on a factor of knowledge of the pattern serves as a two-factor authentication function.

A log-in screen display method setting 403 is an example of a user interface for setting the timing of displaying the log-in screen. As the timing of displaying the log-in screen, either “When starting to operate the MFP” or “When selecting a function” can be set.

In a case where “When selecting a function” is selected, a function(s) that requires a login is further set selectively.

For example, the default selection at the time of shipment of the MFP 101 from a factory is “When selecting a function”, and “personal settings” and “management settings” have been further set by default as functions that require authentication. In a case where “When selecting a function” has been set, a menu screen 601 is displayed upon the activation of the MFP 101. Then, when the user selects “personal settings” or “management settings”, which are functions that require authentication, the log-in screen(s) (602, 603, 604) is displayed, and user authentication is performed.

In a case where “When starting to operate the MFP” has been set, the log-in screen(s) (602, 603, 604) is displayed upon the activation of the MFP 101, and every user who uses the menu 601 of the MFP 101 is asked to go through authentication. The user performs a log-in operation on the log-in screen, and if user authentication is successful, the menu screen is displayed.

A pattern reset setting 404 is a setting regarding the resetting of the pattern. The pattern reset setting 404 provides a choice as to whether or not to enable a function of “performing automatic pattern reissuance in a case where the user forgot the pattern”. An automatic pattern generation condition setting 405 is a setting regarding conditions for automatic generation of a pattern. The automatic pattern generation condition setting 405 provides a choice as to whether or not to set the conditions for automatic generation of a pattern in detail. For examples, settings can be made regarding the number of turns, the number of dots, and angular limitation. Generally speaking, a pattern that has a complex shape containing a larger number of turns, a larger number of dots, and turning with an acute angle(s) and/or with an obtuse angle(s) is greater in terms of combination and is thus more secure. However, such a pattern that has a complex shape is burdensome for the user to input and is prone to an input error. For these reasons, the administrator is recommended to decide the conditions for a pattern to be generated while striking a good balance between security and user convenience.

### User Management

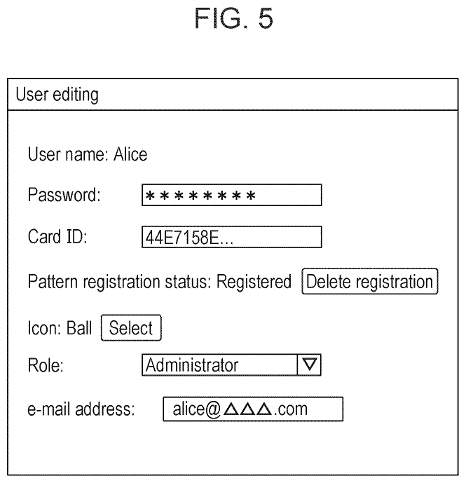

A user account management 406 is an example of a user interface for managing the accounts of users who use the MFP 101. This user interface provides a function of registering a new user account and a function of selecting an already-registered account and editing it or deleting it. For example, assume that “Admin” selects the account of “Alice” in the user account management 406 and presses the edit button. In this case, the remote UI 302 displays a user edit screen illustrated in FIG. 5.

On the user edit screen, a password, a card ID, a role, an e-mail address, an icon image to be displayed on the button of simple login, and the like can be edited and saved. In addition, the user edit screen provides a pattern registration status display function so that the administrator can know the status of registration of the pattern of the general user. Moreover, in anticipation of a case where the general user who forgot the registered pattern requests the administrator to perform pattern resetting, the user edit screen provides a function of deleting the registered pattern. Since pattern registration is supposed to be performed by each individual general user via the local UI, a function of registering a pattern of anyone else by the administrator is not provided.

### Pattern Registration Method

Next, with reference to FIG. 7, how to register a pattern to be used for authentication will now be described. FIG. 7 illustrates a screen flow for a case where “IC card authentication” has been set in the local UI log-in method setting 402 and “When starting to operate the MFP” has been set in the log-in screen display method setting 403.

### Operations for Pattern Registration and Screen Flow

Operations for pattern registration and a screen flow will now be described. In a state in which the log-in screen 604 based on IC card authentication is displayed, the user holds the user's own IC card over the IC card reader 209 to log in to the MFP 101. Upon a successful login to the MFP 101, the menu screen 601 is displayed. The user who wants to use pattern authentication selects “personal settings” on the menu to display a personal setting screen 701. “Personal settings” provide a registration function and a change function regarding the authentication information of the individual user and the profile thereof. For example, the following functions are provided on the personal setting screen 701: a function of “registering/changing an/the icon image that serves as the user's avatar”, a function of “password registration/change”, a function of “pattern registration/change”, and the like.

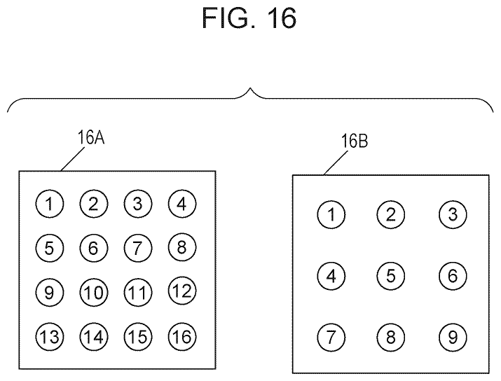

Upon the selection of “pattern registration/change” by the user on the personal setting screen 701, a pattern registration/change screen 702 is displayed. For example, on the pattern registration/change screen 702, a matrix that is made up of sixteen dots in total arranged in four columns and four rows is displayed, and the user is asked to run the user's fingertip on the dot-displayed screen area to draw an arbitrary shape thereon. For the purpose of preventing an input error, the user may be asked to input the same shape more than once. For example, dots through which the user's fingertip has passed and the sequential order thereof are stored as pattern information into the user account table (Table 1) in association with the account of the user who is currently logged in. The pattern information can be stored with, for example, internal numbering of the dots arranged in the 4×4 layout (sixteen dots) as illustrated by 16A in FIG. 16.

For example, the pattern shape (pattern information) illustrated on the pattern registration/change screen 702 can be expressed as “1, 2, 3, 4, 7, 10, 13, 14, and 15”. The pattern information is encrypted when stored into the user account table (Table 1). Alternatively, the pattern information may be stored after conversion into a digest by using a hash function. In general, generating a digest by using PBKDF2 (password-based key derivation function 2) is recommended. Therefore, a salt used for PBKDF2 and a digest calculated through PBKDF2 may be stored. Upon a successful pattern information registration, a screen 706 for letting the user know that the registration has completed is displayed. Display returns to the screen 701 of personal settings when the user closes the screen 706.

A button 703 for moving on to a screen for automatic generation of a pattern may be displayed on the pattern registration/change screen 702. In a case where the administrator has not made the setting 405 regarding conditions for automatic generation of a pattern, a screen 704 may be displayed, and the user may be allowed to set the conditions for automatic generation of a pattern by themselves. In a case where the administrator has made the setting 405 regarding conditions for automatic generation of a pattern, the pattern is generated automatically in accordance with the conditions having been set by the administrator. The pattern generated automatically is displayed on a screen 705. After memorizing the pattern, the user presses the register button. The system may preferably be configured such that the user is allowed to press the “generate automatically” button again in a case where the user does not like the pattern generated automatically. Note that the numbers illustrated on the dots on the screen 705 do not mean the numbers in internal dot numbering but mean the sequential order of selection of the dots in the generated pattern.

A setting that forces the user to use a pattern may be provided, and the user who logs in through IC card authentication or through simple login first time may be guided to the display of the pattern registration/change screen 702 so that the setting of a pattern will be necessarily performed.

### Registrable Pattern

In the present embodiment, the pattern that the user can register is based on the following rules:
Four dots or more must be selected.
Assuming that two selected dots are connected to each other by a straight line segment, intervening dots that lie therebetween are regarded as being selected in an order from the one located closer to the starting point of this selection. That is, suppose that two dots are selected in an order of 1→4. In this case, assuming that dot No. 2 and dot No. 3 of internal numbering have not been selected yet, it is regarded that the selection of “1, 2, 3, and 4” is made by this stroke in this order.
A dot that has already been selected must not be selected again. However, it is allowed to select another dot by passing through an already-selected dot(s). That is, suppose that the user runs the user's fingertip through dots in an order of “1, 6, 11, 7, 3, 6, and 9” when registering a pattern. In this case, the second passing through dot No. 6 is not recorded. Therefore, the pattern stored in this case is “1, 6, 11, 7, 3, and 9”.

The rules described above constitute just an example. The disclosed technique can be applied even with rules different from those described above. This example shall not be construed to restrict the content of the present disclosure.

### Operation Performed at the Time of Pattern Authentication

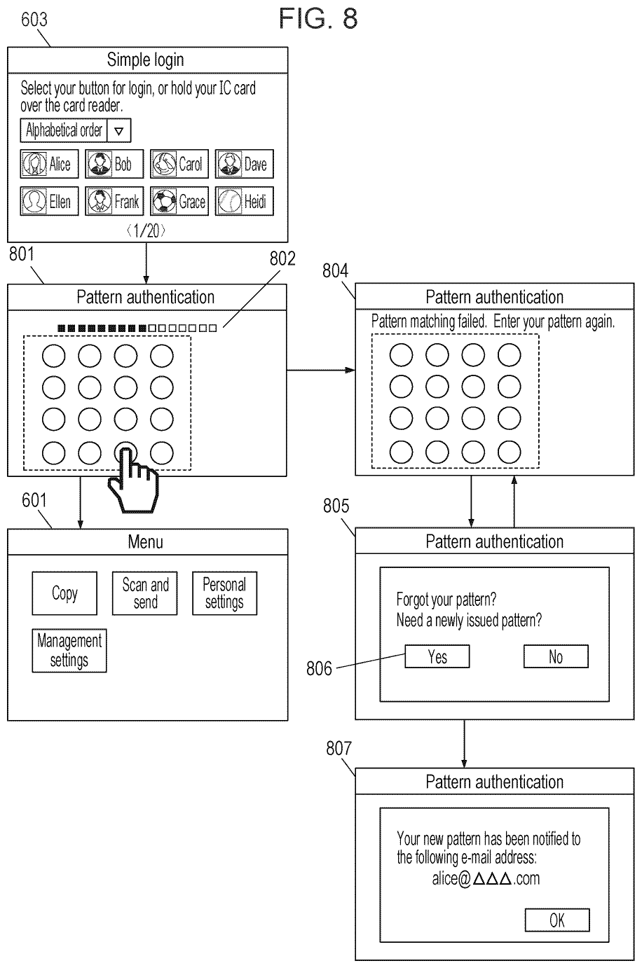

Next, with reference to FIG. 8, operation performed at the time of pattern authentication will now be described. FIG. 8 is a diagram illustrating screen transition for a case where the user who has already registered pattern information logs in to the MFP 101 by using simple login and pattern authentication.

In a state in which the simple log-in screen 603 is displayed, the user presses the button on which the user's own name and the user's own avatar image are displayed, thereby attempting to log in to the MFP 101.

The log-in service 303 identifies the user account corresponding to the pressed button.

The user account table (Table 1) is looked up to confirm that there exists an already-registered pattern for the identified user account, and a pattern authentication screen 801 is displayed.

The user touches a pattern input area displayed on the operation panel 205 with the finger, and then slides the finger without releasing the fingertip from the operation panel 205, thereby selecting dots to draw a pattern shape. While the user is performing this finger-sliding operation, for the purpose of keeping the operation panel 205 safe from prying eyes of any third-party user and preventing the inputted pattern shape from being guessed on the basis of a graphic action of the operation panel 205, it is better not to change the appearance of dots or display a line between dots or display a finger trajectory. However, if there is no UI response at all, the user might feel unsure and doubt a UI hang-up, which is not the case. To avoid this, a response to the pattern input is made by changing the display of an indicator 802.

After drawing the pattern shape, the user releases the fingertip from the operation panel 205. Upon detecting the release, the inputted pattern shape is converted into an internal storage format (such as “1, 2, 3, 4, 7, 10, 13, 14, and 15” or a hash value) so that it can be compared with pre-stored data. Pattern authentication is performed by comparing the inputted pattern shape with the pre-registered pattern of the identified user.

In a case of a pattern match, the authentication is successful, and the user is allowed to log in to the MFP 101. Specifically, information about the user who has succeeded in the authentication is read out from the user account table (Table 1) into the RAM 203, and a structural body (hereinafter referred to as “log-in context”) for storing user information of the user who is currently logged in is rendered into instance. The information that is stored into the log-in context includes user name, role, e-mail address, and the like as shown in Table 3.

TABLE 3

| Item | Value |
|---|---|
| User name | Alice |
| Role | Administrator |
| e-mail address | alice@ΔΔΔ.com |

The log-in service 303 notifies the local UI 301 of the login of the user to the MFP 101, together with the log-in context. The local UI 301 displays the menu screen 601. In a case where the inputted pattern does not agree with the pre-registered pattern, a pattern authentication screen 804 is displayed, accompanied by a message saying that the authentication is not successful. If an automatic pattern reissuance function is enabled, the automatic pattern reissuance function is provided to the user. In a case where the user fails in pattern authentication successively a predetermined number of times, the automatic pattern reissuance function displays a screen 805 including the following questions: “Forgot your pattern?”; “Need a newly issued pattern?” The predetermined number of times may be once or three times. The predetermined number of times may be pre-settable by the administrator. If the user presses a “Yes” button 806, the log-in service 303 generates a new pattern automatically, and performs notification to the e-mail address that is the user's notification address. Upon completion of e-mail transmission, a screen 807 including a message is displayed to the effect that an e-mail has been sent.

### Flow of Automatic Generation of Pattern and Notification Processing

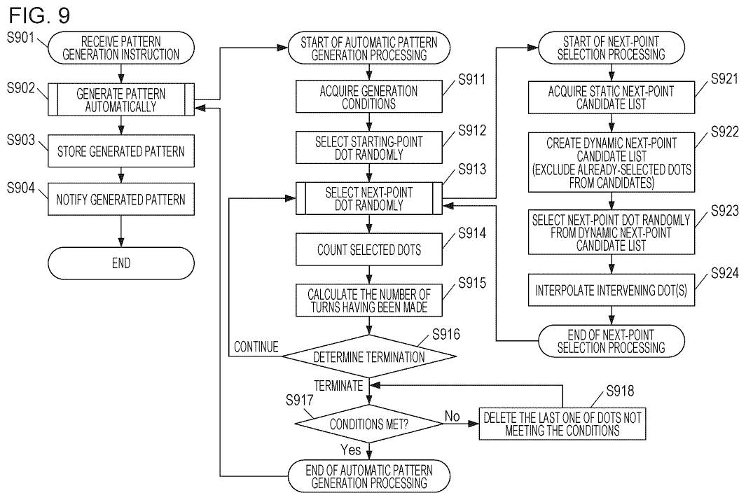

With reference to a flowchart of FIG. 9, a flow of automatic generation of a pattern after the pressing of the “Yes” button 806 by the user, and a flow of e-mail notification, will now be described. In the present embodiment, steps of the flow described below are recorded in a software program(s) such as the log-in service 303. The software program is stored in a non-volatile storage such as the ROM 202, the HDD 204, etc., is loaded onto the RAM 203, and is run by the CPU 201 for flow execution.

The processing in this flowchart is initiated as follows. The log-in service 303 receives a pattern generation instruction (S901) by detecting the pressing of the “Yes” button 806 on the screen 805 by the user, and starts pattern generation processing.

In S902, the log-in service 303 generates a pattern automatically. In S903, the log-in service 303 stores information on the generated pattern into the HDD 204 in association with the account of the identified user. In this step, the log-in service 303 may determine whether or not the new pattern generated automatically is identical to the pattern used currently by the user, and, if identical, may repeat the pattern generation processing in S902 until a different pattern is generated. In a case where there is a log of patterns that were used in the past, the log-in service 303 may determine whether or not the new pattern generated automatically is identical to any pattern used in the past, and, if identical, may repeat the pattern generation processing in S902 until a different pattern is generated.

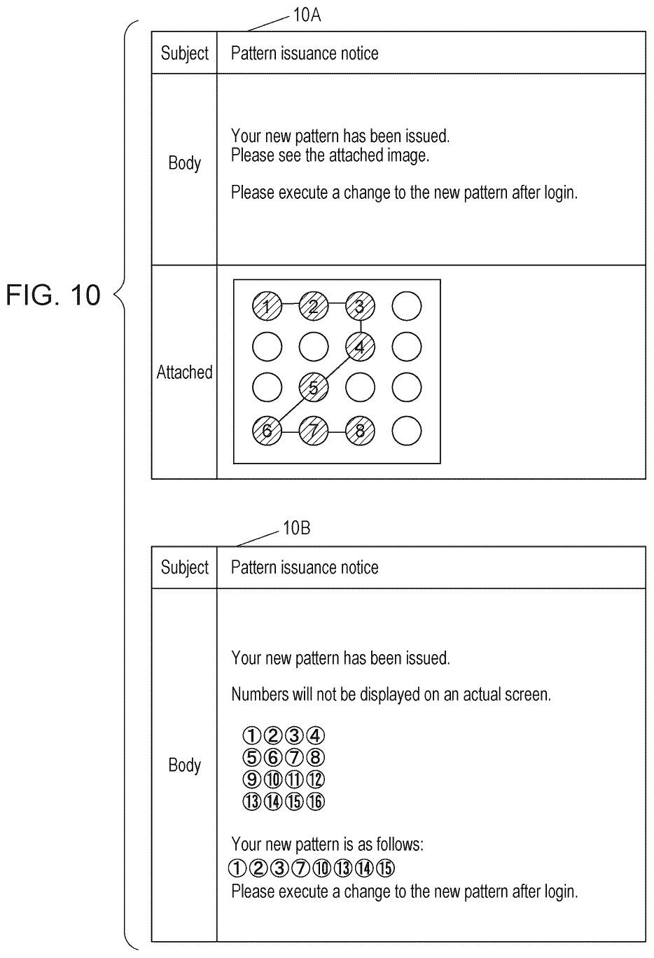

Next, in S904, the log-in service 303 notifies the user of the new generated pattern. Specifically, the user account table (Table 1) is looked up to acquire the e-mail address associated with the account of the identified user, and e-mail notification of information on the pattern generated automatically is performed to the destination specified by the e-mail address. Examples of this notification e-mail are illustrated in FIG. 10.

In the example 10A, an image that shows information on the pattern generated automatically is attached to an e-mail. The log-in service 303 generates an image file that is in an image format of JPEG, GIF, BMP, PNG, or the like on the basis of information on the pattern generated automatically, and attaches the image file to an e-mail. The text of the e-mail contains a “Please find the attached image” message. Note that the numbers illustrated on the dots in 10A do not mean the numbers in internal dot numbering but mean the sequential order of selection of the dots by the user. The order of selection may be shown by using, instead of the numbers, arrows, signs indicating the starting point and the ending point, and/or graphic presentation.

The example 10B discloses a case where information on the pattern generated automatically is communicated in the form of not an image but a text in the body of the e-mail. The internal dot numbering and the sequential order of selection are expressed in sentences. The order of selection may be shown by using, instead of the numbers, arrows, and/or signs indicating the starting point and the ending point. The e-mail transmission is performed using SMTP, POP, and IMAP, which are commonly used e-mail protocols. The image can be attached using the MIME (multi-purpose internet mail extension) standard.

By confirming the received e-mail, the user can know the new pattern shape generated automatically. The user can perform a login by entering the new pattern on the pattern authentication screen 801, which is displayed in response to the user's pressing of the button on which the user's own name and the user's own avatar image are displayed on the simple log-in screen 603.

The pattern generated automatically may be stored as a temporary pattern that is distinct from the currently set pattern. In a case where the new pattern notified by e-mail is not used for the purpose of a login within a predetermined time, it is advisable to delete the new pattern stored temporarily and return to a state in which the currently set pattern can be used. This makes it possible to defeat a willful attempt by a third party to tamper the user's pattern.

When the user logs in by using the new pattern notified by e-mail, a pattern change screen may be displayed on the operation panel 205 to allow the user themselves to set the new pattern. This makes it possible to reduce the risk that the new pattern becomes known to a third-party user who has intercepted the e-mail through illicit means or a third-party user who has stolen a glance at the e-mail.

### Detailed Flow of S902

A detailed flow (from S911 to S917) of the automatic pattern generation processing in S902 will now be described.

In S911, the log-in service 303 acquires pattern generation conditions. In a case where one or more pattern generation conditions (the number of turns, the number of dots, angular limitation) were set by the administrator via the UI of the automatic pattern generation condition setting 405, these conditions are acquired. In a case where no pattern generation conditions were set by the administrator, the generation may be performed under default conditions at the time of factory shipment.

Next, in S912, the log-in service 303 selects the starting point from among the sixteen dots of a pattern matrix randomly. For example, if the program is a Java program, a number selected randomly from among 1 to 16 can be substituted into i by using a standard function shown below. Since nextInt (16) generates a random number from 0 to 15, 1 is added thereto. In a case where the function of nextInt (16) cannot be used, it is possible to use a remainder of division calculated by dividing a random number having an appropriate length by 16 as an alternative to nextInt (16).
SecureRandom sr=SecureRandom. getlnstance(“SHA1PRNG”);
int i=sr1. nextInt (16)+1.

The selected point is stored as an already-selected dot into an already-selected-dot list.

Next, in S913, the log-in service 303 selects the next point(s) randomly. In S913, one or more next points are selected. A detailed explanation of a flow of S913 will be given later. The selected points are stored into the already-selected-dot list in the order of selection. Next, in S914, the log-in service 303 counts the number of dots stored in the already-selected-dot list. In a case where the pattern generation conditions contain the number of turns, in S915, the number of turns having been made is calculated by using the already-selected-dot list. A detailed explanation of how to calculate the number of turns having been made will be given later.

Next, in S916, the calculated number of already-selected dots and the calculated number of turns described above are compared with the pattern generation conditions (for example, the number of turns: three turns; the number of dots: four to nine dots) to determine whether there is a need to select another next point or the next-point selection process should be terminated. In a case where the pattern generation conditions have not been met yet, the processing from S913 to S916 is repeated, and the next-point selection process continues until the conditions are met. The step of S915 may be skipped because there is no need to calculate the number of turns having been made until four dots or more are selected, where four is the number demanded by the rule. For example, in a case where the set number of turns is three, the next-point selection process continues until the number of turns having been made is determined to be four, instead of terminating the next-point selection process at the point in time of determining that the number of turns having been made is three. This is because the next point after the third turning point is not always a turning point. Accordingly, the next-point selection process continues until the number of turns having been made is determined to be four. In a case where the set upper limit of the number of dots is nine, the next-point selection process is terminated when nine dots or more are contained in the already-selected-dot list.

Next, in S917, the log-in service 303 determines whether or not the pattern according to the already-selected-dot list meets the conditions. For example, in a case where the number of selected dots is ten or more or the number of turns having been made is four or more, the conditions are not met; therefore, in this case, in S918, the last one dot is deleted from the already-selected-dot list. Then, the process flow returns to S917, the number of dots and the number of turns having been made are calculated again, and it is further determined whether or not the conditions are met. The processing in S917 and S918 are repeated until the conditions are met.

The automatic pattern generation processing ends when it is determined in S917 that the conditions are met. At this point in time, the dots contained in the already-selected-dot list and the order of selection thereof specify the pattern shape.

### Detailed Flow of S913

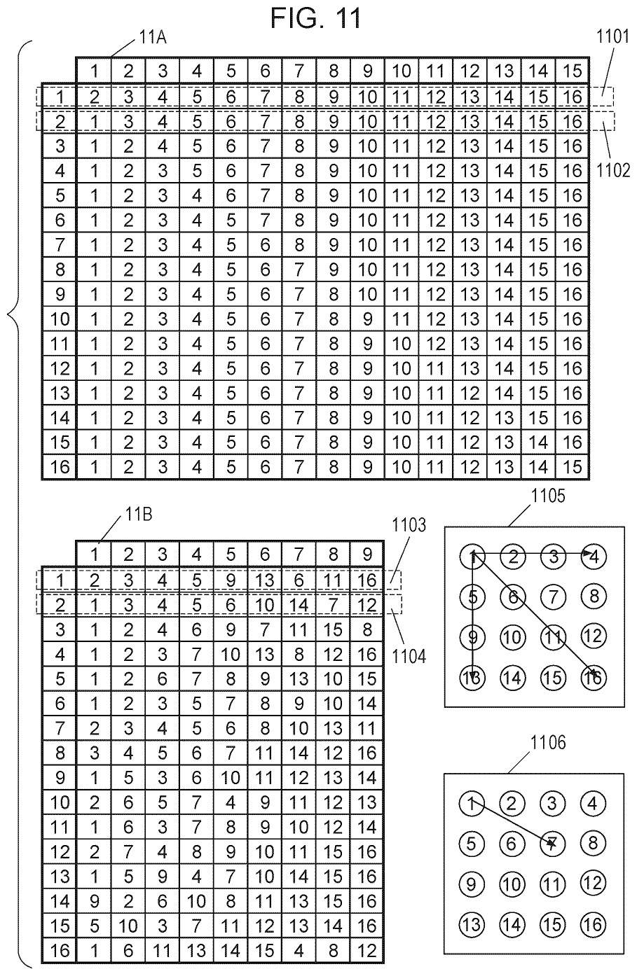

A detailed flow (from S921 to S924) of the processing of selecting the next point(s) randomly in S913 will now be described. The log-in service 303 performs next-point selection by using a next-point candidate list. FIG. 11 illustrates static next-point candidate list examples. The example 11A is a table for a case where no limitation is imposed on next-point candidates. For example, the first row denoted by reference numeral 1101 in the table of 11A indicates that dots to which a move can be made from dot No. 1 are “2, 3, 4, 5, 6, 7, 8, 9, 10, 11, 12, 13, 14, 15, and 16”, excluding dot No. 1 itself. The second row denoted by reference numeral 1102 in this table indicates that dots to which a move can be made from dot No. 2 are “1, 3, 4, 5, 6, 7, 8, 9, 10, 11, 12, 13, 14, 15, and 16”, excluding dot No. 2 itself. The same holds true for the subsequent rows.

The example 11B is a table for a case where a limitation is imposed on next-point candidates. For example, the first row denoted by reference numeral 1103 in the table of 11B indicates that, as shown by vectors in 1105, dots to which a move can be made from dot No. 1 are “2, 3, 4, 5, 9, 13, 6, 11, and 16”. That is, the following pattern shape is not permitted: a pattern shape including such an angle that demands selecting dot No. 7 while going through a gap between dot No. 2 and dot No. 6 as indicated by a vector 1→7 in 1106, for example. In other words, making a turn at any angle other than 45°, 90°, and 135° is not permitted. The second row denoted by reference numeral 1104 in this table indicates that dots to which a move can be made from dot No. 2 are “1, 3, 4, 5, 6, 10, 14, 7, and 12”. The same holds true for the subsequent rows.

In a case where “Impose angular limitations” was enabled by the administrator in the automatic pattern generation condition setting 405, in S921, the static next-point candidate list 11B is acquired and used. For example, if the last-selected dot is dot No. 2, “1, 3, 4, 5, 6, 10, 14, 7, and 12” on the second row of 11B is acquired as the static next-point candidate list.

Next, in S922, the log-in service 303 creates a dynamic next-point candidate list by removing the dots stored in the already-selected-dot list from “1, 3, 4, 5, 6, 10, 14, 7, and 12” of the static next-point candidate list. If the dots stored in the already-selected-dot list are “1 and 2”, the dynamic next-point candidate list is “3, 4, 5, 6, 10, 14, 7, and 12”.

In a case where “Impose angular limitations” was not enabled by the administrator, all dots excluding the already-selected dots are candidates. Therefore, the dynamic next-point candidate list may be created by deleting the dots stored in the already-selected-dot list from a list of all dots without using the table 11A.

For example, if the dots stored in the already-selected-dot list are “1 and 2”, the dynamic next-point candidate list is “3, 4, 5, 6, 7, 8, 9, 10, 11, 12, 13, 14, 15, and 16” obtained by removing the already-selected dots from the list of all dots.

Next, in S923, the log-in service 303 selects the next point randomly from the created dynamic next-point candidate list. For example, in a case where the dynamic next-point candidate list contains eight dots, indices 1 to 8 are assigned to “3, 4, 5, 6, 10, 14, 7, and 12” respectively in this order from the head, a random number I from 1 to 8 is generated, and the I-th dot indexed by the generated random number is selected as the next point. For example, if the generated random number is six, dot No. 14, which is the sixth one in the list, is selected.

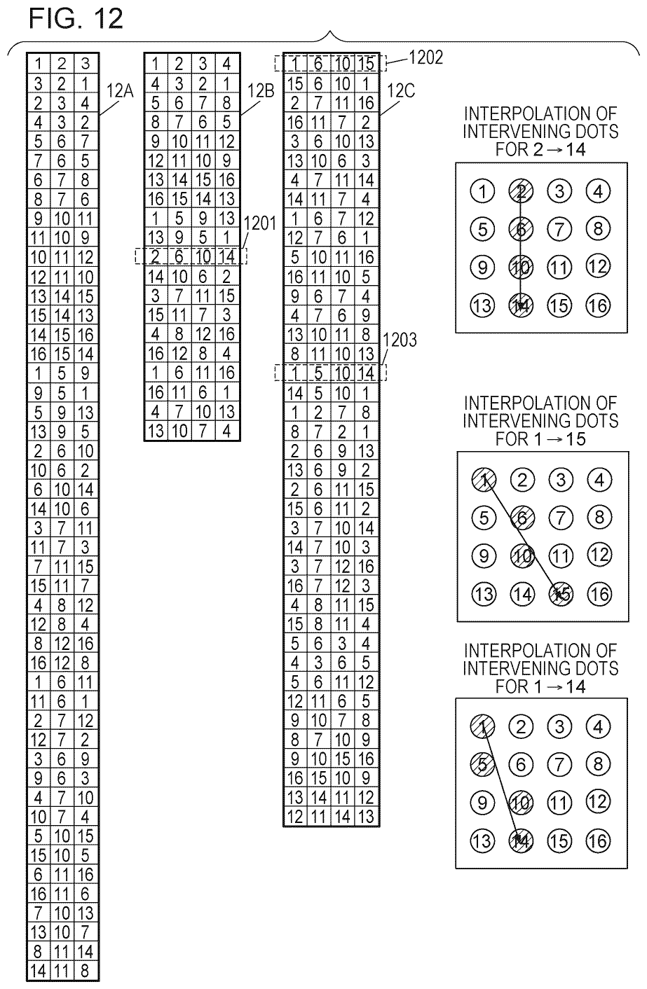

Next, the log-in service 303 checks whether or not there is any intervening dot jumped by the selection. In a case where there are intervening dots, the intervening dots are interpolated in an order from the one located closer to the starting point of this selection. For example, if dot No. 2 and dot No. 14 are connected to each other by a straight line segment, dot No. 6 and dot No. 10 lie therebetween. If neither of dot No. 6 and dot No. 10 is contained in the already-selected-dot list, 6 and 10 are interpolated after 2, and the already-selected-dot list is overwritten as “1, 2, 6, 10, and 14”. For the purpose of checking whether or not there is any intervening dot, the log-in service 303 includes pre-stored tables indicating dot continuity illustrated in FIG. 12. For example, a search for a table row beginning with a starting point of 2 and terminating with an ending point of 14 is performed by checking each row of the tables illustrated in FIG. 12. As a result of this search, a row 1201 is found, and it is found that there exist intervening dots No. 2 and No. 6.

The table illustrated in 12C defines sets each including a starting point and an ending point difficult to be selected without going through an intervening dots lying therebetween, though not on a straight line, to be exact. For example, a row 1202 indicates that it is difficult to select dot No. 15 without going through intervening dots No. 6 and No. 10 lying therebetween when a selection of 1→15 is performed. For this reason, in a case where dot No. 15 is selected randomly as the next point after dot No. 1, intervening dots No. 6 and No. 10 are interpolated by being deemed as selected. Similarly, a row 1203 indicates that it is difficult to select dot No. 14 without going through intervening dots No. 5 and No. 10 lying therebetween when a selection of 1→14 is performed. For this reason, in a case where dot No. 14 is selected randomly as the next point after dot No. 1, intervening dots No. 5 and No. 10 are interpolated by being deemed as selected.

Even in a case where no angular limitation is imposed, using the table of FIG. 12C makes it possible to prevent the generation of a pattern that is actually difficult to be traced with a fingertip. Through the above processing, in the random selection of the next point(s) in S913, one to three dots are added into the already-selected-dot list.

### Method for Calculating the Number of Turns Having Been Made

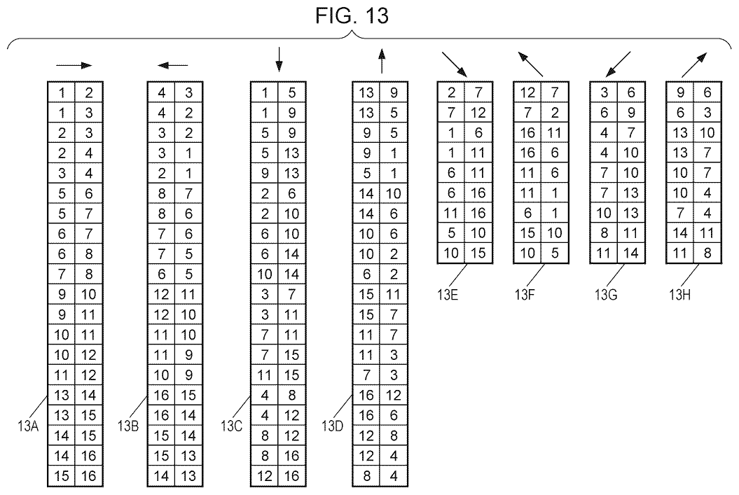

A method for calculating the number of turns having been made in S915 will now be described in detail. For the purpose of calculating the number of turns having been made, the log-in service 303 includes pre-stored vector tables each including a group of moves that are in the same direction (have the same vector) from a starting point to an ending point as illustrated in FIG. 13.

For example, in a case where the already-selected-dot list is “1, 2, 6, 10, and 14”, a combination “1, 2” is searched through tables 13A to 13H. The combination “1, 2” can be found in the table 13A; therefore, it is stored that the table 13A contains this combination. Next, a combination “2, 6”, which is the next move, is searched. The combination “2, 6” can be found in the table 13C, and this table is not identical to the stored table 13A. In a case where the table in which the combination can be found is not identical to the stored table, it is determined that a turn has been made, and the count of the number of turns is incremented.

The table looked up last is stored and, then, a combination “6, 10” is searched. The combination “6, 10” can be found in the table 13C, which is identical to the last one; therefore, it is possible to determine that no turn has been made. As described above, by searching through the vector tables in FIG. 13 for each paired two dots sequentially from the head of the already-selected-dot list, it is possible to calculate the number of turns having been made. For a combination of two dots that cannot be found in any of the tables 13A to 13H, in no case there is a continuous vector between these two dots. For this reason, if the combination cannot be found in any of the tables 13A to 13H, it is determined that a turn has been made, and the count of the number of turns is incremented.

### First Example of Pattern Generation

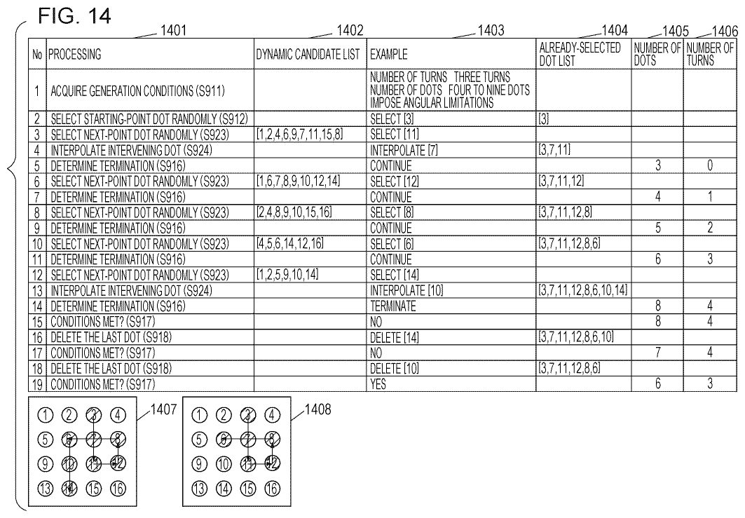

With reference to FIG. 14, a flow of a series of processes for pattern generation, and changes in the already-selected-dot list, will now be described. Column 1401 shows the processing steps illustrated in FIG. 9. Column 1402 shows an example of the dynamic next-point candidate list used in S923. Column 1403 shows an example of the result obtained from each processing. Column 1404 shows changes in the already-selected-dot list. Column 1405 shows the number of dots obtained from the already-selected-dot list. Column 1406 shows the number of turns having been made, which is calculated from the already-selected-dot list.

In processing No. 1, pattern generation conditions are acquired. Assume that the following conditions are acquired: “the number of turns: three turns”, “the number of dots: four to nine dots”, and “impose angular limitations”. Since the angular limitations are ON, the static next-point candidate list 11B is used. This processing corresponds to the processing in S911 of FIG. 9.

In processing No. 2, assume that “3” is selected as a result of random selection of the starting point. Accordingly, “3” is stored into the already-selected-dot list. This processing corresponds to the processing in S912 of FIG. 9. In processing No. 3, available choices in the next-point candidate list used are “1, 2, 4, 6, 9, 7, 11, 15, and 8”. Assume that “11” is selected randomly. This processing corresponds to the processing in S923 of FIG. 9. In processing No. 4, intervening point interpolation is performed. Since dot No. 7 lies between dot No. 3 and dot No. 11, this intervening dot No. 7 is interpolated. Accordingly, the content of the already-selected-dot list turns into “3, 7, and 11”. This processing corresponds to the processing in S924 of FIG. 9. In processing No. 5, termination determination is performed using the number of dots obtained from the already-selected-dot list and the calculated number of turns having been made. At this point in time, the number of dots is just three, which is short of the minimum required number of dots, four. Therefore, it is determined here that the next-point selection process should continue. This processing corresponds to the processing in S914, S915, and S916 of FIG. 9.

In processing No. 6, the next point is further selected randomly. The dynamic next-point candidate list used here is “1, 6, 7, 8, 9, 10, 12, and 14” obtained by removing the already-selected dots from the static next-point candidate list for “11”. Assume that “12” is selected here. The content of the already-selected-dot list turns into “3, 7, 11, and 12”. This processing corresponds to the processing in S923 of FIG. 9. In processing No. 7, the termination determination is performed. Though the number of dots have reached four, the condition of three turns has not been met yet. Therefore, it is determined here that the next-point selection process should continue. This processing corresponds to the processing in S916 of FIG. 9. In processing No. 8, the next point is further selected randomly. Assume that “8” is selected here. The content of the already-selected-dot list turns into “3, 7, 11, 12, and 8”. This processing corresponds to the processing in S923 of FIG. 9. In processing No. 9, the termination determination is performed. Since the condition of three turns has not been met yet, it is determined here that the next-point selection process should continue. This processing corresponds to the processing in S916 of FIG. 9.

In processing No. 10, the next point is further selected randomly. Assume that “6” is selected here. The content of the already-selected-dot list turns into “3, 7, 11, 12, 8, and 6”. Though dot No. 7 lies between dot No. 8 and dot No. 6, interpolation is not performed because dot No. 7 has already been selected. This processing corresponds to the processing in S923 of FIG. 9. In processing No. 11, the termination determination is performed. Though three turns have been made, there is a possibility that dot No. 5 might be selected as the next point without making any further turn. Therefore, it is determined here that the next-point selection process should continue. This processing corresponds to the processing in S916 of FIG. 9. In processing No. 12, the next point is further selected randomly. Assume that “14” is selected here. This processing corresponds to the processing in S923 of FIG. 9. In processing No. 13, intervening point interpolation is performed. Since dot No. 10 lies between dot No. 6 and dot No. 14, this intervening dot No. 10 is interpolated. Accordingly, the content of the already-selected-dot list turns into “3, 7, 11, 12, 8, 6, 10, and 14”. The pattern having been generated at this point in time can be illustrated as a pattern 1407. This processing corresponds to the processing in S924 of FIG. 9.

In processing No. 14, the termination determination is performed. Since the number of turns having been made is four, exceeding three, it is determined here that the next-point selection process should terminate. This processing corresponds to the processing in S916 of FIG. 9. In processing No. 15, it is determined whether or not the conditions are met. Since the number of turns having been made is four, the determination result is “No”. This processing corresponds to the processing in S917 of FIG. 9. In processing No. 16, the last point, dot No. 14, in the already-selected-dot list is deleted. Accordingly, the content of the already-selected-dot list turns into “3, 7, 11, 12, 8, 6, and 10”. This processing corresponds to the processing in S918 of FIG. 9. In processing No. 17, “the number of dots” and “the number of turns having been made” are calculated from the already-selected-dot list, and it is determined whether or not the conditions are met. Since the number of turns having been made still remains four, the determination result is “No”. This processing corresponds to the processing in S917 of FIG. 9.

In processing No. 18, the last point in the already-selected-dot list, dot No. 10, is deleted to turn the content of the already-selected-dot list into “3, 7, 11, 12, 8, and 6”. This processing corresponds to the processing in S918 of FIG. 9. In processing No. 19, it is determined whether or not the generated pattern satisfies the conditions. Since the number of dots is six and the number of turns having been made is three, the determination result is “Yes”. This processing corresponds to the processing in S917 of FIG. 9. The resultant already-selected-dot list “3, 7, 11, 12, 8, and 6” is taken as the finally generated pattern. The finally generated pattern can be illustrated as a pattern 1408.

### Second Example of Pattern Generation

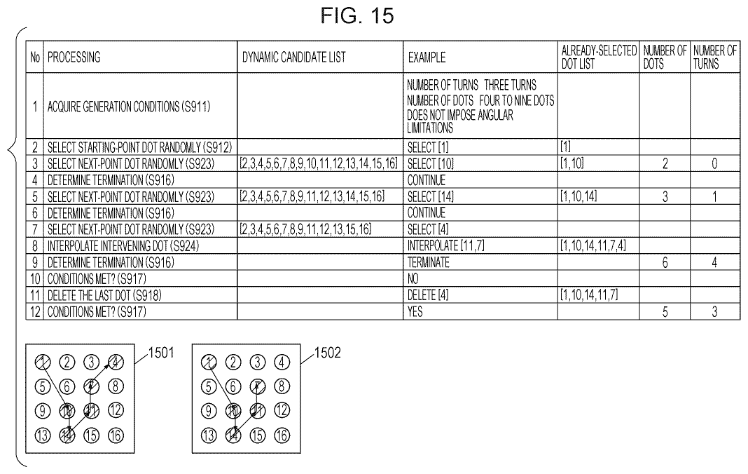

With reference to FIG. 15, a variation example of a flow of a series of processes for pattern generation, and changes in the already-selected-dot list, will now be described. In processing No. 1, pattern generation conditions are acquired. Assume that the following conditions are acquired: “the number of turns: three turns”, “the number of dots: four to nine dots”, and “does not impose angular limitations”. Since no angular limitations are imposed, the dynamic next-point candidate list is a list obtained by removing the already-selected dots from all dots. This processing corresponds to the processing in S911 of FIG. 9. In processing No. 2, the starting point is selected randomly. Assume that “1” is selected as the result of random selection. Accordingly, “1” is stored into the already-selected-dot list. This processing corresponds to the processing in S912 of FIG. 9. In processing No. 3, the next-point candidate list used is “2, 3, 4, 5, 6, 7, 8, 9, 10, 11, 12, 13, 14, 15, and 16”. Assume that “10” is selected randomly here. This processing corresponds to the processing in S923 of FIG. 9.

In processing No. 4, termination determination is performed. At this point in time, the number of dots is just two, which is short of the minimum required number of dots, four. Therefore, it is determined here that the next-point selection process should continue. This processing corresponds to the processing in S916 of FIG. 9.

In processing No. 5, the next point is further selected randomly. Assume that “14” is selected here. This processing corresponds to the processing in S923 of FIG. 9. In processing No. 6, the termination determination is performed. At this point in time, the number of dots is just three, which is short of the minimum required number of dots, four. Therefore, it is determined here that the next-point selection process should continue.

This processing corresponds to the processing in S916 of FIG. 9. In processing No. 7, the next point is further selected randomly. Assume that “4” is selected here. This processing corresponds to the processing in S923 of FIG. 9.

In processing No. 8, intervening point interpolation is performed. The table of 12C is looked up, and dots No. 11 and No. 7, which lie between dot No. 14 and dot No. 4, are interpolated. The content of the already-selected-dot list turns into “1, 10, 14, 11, 7, and 4”. This processing corresponds to the processing in S924 of FIG. 9. In processing No. 9, the termination determination is performed. Since the number of turns having been made is four, exceeding three, it is determined here that the next-point selection process should terminate. The pattern having been generated at this point in time can be illustrated as a pattern 1501. This processing corresponds to the processing in S916 of FIG. 9. In processing No. 10, it is determined whether or not the generated pattern satisfies the conditions. Since the number of turns having been made is four, the determination result is “No”. This processing corresponds to the processing in S917 of FIG. 9. In processing No. 11, the last point in the already-selected-dot list, dot No. 4, is deleted to turn the content of the already-selected-dot list into “1, 10, 14, 11, and 7”. This processing corresponds to the processing in S918 of FIG. 9. In processing No. 12, it is determined whether or not the generated pattern satisfies the conditions. Since the number of dots is five and the number of turns having been made is three, the determination result is “Yes”. This processing corresponds to the processing in S917 of FIG. 9. The resultant already-selected-dot list is “1, 10, 14, 11, and 7”, and this finally generated pattern can be illustrated as a pattern 1502.

The function of pattern generation can be used not only for reissuance in a case where the user forgot the pattern but also for pattern generation at the time of initial pattern registration illustrated in 702 to 705 of FIG. 7. In this case, a pattern generation instruction is received by operation of the automatic pattern generation button, and the flow illustrated in FIG. 9 is initiated. The notifier of the generated pattern in S904 in this case is not e-mail but the UI 705.

This makes it possible to offer an automatic pattern generation function to a user who is wondering what kind of pattern to register. Moreover, generally speaking, a pattern that is generated automatically is more difficult to guess and is thus more secure than a pattern that a user thinks of.

When the administrator performs initial registration of a new general user account, an MFP may generate a pattern and notify the pattern to the e-mail address of the registered general user.

This makes it possible to preset a pattern for each account simultaneously with new account creation.

### Effects of Present Disclosure

As described above, the user who forgot the registered pattern is able to receive pattern reissuance through the user's own operations and log in to the MFP to make it available for use again. Moreover, in the present embodiment, it is possible to limit the conditions of a pattern to be generated (the number of dots, the number of turns, and the angle of turning). This makes it possible to avoid poor user convenience due to generating an excessively complex pattern shape.

Moreover, in the present embodiment, by making settings, it is possible to change the conditions of a pattern to be generated. This makes it possible to change the conditions of the pattern while taking into account a good balance between security demanded by the administrator and user convenience.

### OTHER EMBODIMENTS

Though an example of a pattern in a 4×4 matrix layout (sixteen dots) has been described in the first embodiment, the disclosed technique can be applied to a pattern in a 3×3 matrix layout (nine dots) such as one illustrated by 16B in FIG. 16 to perform automatic pattern generation.

This will work by preparing, for a 3×3 matrix layout (nine dots), next-point candidate lists corresponding to those of FIG. 11, dot-continuity tables corresponding to those of FIG. 12, and vector tables corresponding to those of FIG. 13.

Alternatively, pattern data of every possible combination may be pre-stored in an MFP, and, upon receiving a request for pattern generation from a user, pattern data may be selected from the pre-stored list. For example, there exist approximately 380,000 patterns for a pattern shape that can be generated with four dots or more on a 3×3 (nine-dot) matrix. One is selected from among 380,000 patterns of pattern data. There exist approximately 600 billion patterns for a pattern shape that can be generated with four dots or more on a 4×4 (sixteen-dot) matrix. The number of patterns for a pattern shape with four dots or more and nine dots or less is approximately a hundred million. A large storage area is needed for pre-storing every pattern data. By storing pattern conditions and complexities (the number of dots, the number of turns, the angle of turning) in association with pattern data, pattern data that meet specified conditions may be configured to be extractable from a storage area.

The present disclosure may be embodied by supplying, to a system or an apparatus via a network or in the form of a storage medium, a program that realizes one or more functions of each embodiment described above, and by causing one or more processors in the computer of the system or the apparatus to read out and run the program. The present disclosure may be embodied by means of circuitry (e.g., ASIC, FPGA) that realizes the one or more functions.

With the present disclosure, the user who forgot the registered pattern is able to receive pattern reissuance through the user's own operations and use the functions of an information processing apparatus, including a print function.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-110475, filed on Jul. 5, 2023, which is hereby incorporated by reference herein in its entirety.

What is claimed is:

1. An information processing apparatus configured to offer at least a print function through execution of authentication in log-in operation, the information processing apparatus comprising:
one or more memories that store a set of instructions; and
one or more processors that execute the instructions, the instructions, when executed, causing the information processing apparatus to perform operations comprising:
receiving an instruction for generating a pattern to be used in pattern authentication, the pattern authentication being one of ways of the authentication in the log-in operation;
generating the pattern;
storing the generated pattern; and
performing notification, wherein, in a case of a failure in the log-in operation, the generating of the pattern is redone, and, in the notification, information regarding a pattern generated again by redoing the generating is notified to a notification address corresponding to a user registered in the information processing apparatus.

2. The information processing apparatus according to claim 1, wherein
in the notification, the information regarding the pattern generated again is notified by electronic mail.

3. The information processing apparatus according to claim 1, wherein
in the generating, a pattern that meets pattern generation conditions set on a setting screen of user authentication settings of the information processing apparatus is generated.

4. The information processing apparatus according to claim 3, wherein
the pattern generation conditions set on the setting screen include at least one of a number of dots in the pattern, a number of turns, and an angle of turning.

5. The information processing apparatus according to claim 1, wherein
the operations further comprise using a static next-point candidate list that shows points to which a move is possible from each point.

6. A control method of an information processing apparatus configured to offer at least a print function through execution of authentication in log-in operation, the control method comprising:
receiving an instruction for generating a pattern to be used in pattern authentication, the pattern authentication being one of ways of the authentication in the log-in operation;
generating the pattern;
storing the generated pattern; and
performing notification, wherein, in a case of a failure in the log-in operation, the generating of the pattern is redone, and, in the notification, information regarding a pattern generated again by redoing the generating is notified to a notification address corresponding to a user registered in the information processing apparatus.

7. The control method according to claim 6, wherein
in the notification, the information regarding the pattern generated again is notified by electronic mail.

8. The control method according to claim 6, wherein
in the generating, a pattern that meets pattern generation conditions set on a setting screen of user authentication settings of the information processing apparatus is generated.

9. The control method according to claim 8, wherein
the pattern generation conditions set on the setting screen include at least one of a number of dots in the pattern, a number of turns, and an angle of turning.

10. The control method according to claim 6, wherein
a static next-point candidate list that shows points to which a move is possible from each point is used.

11. A non-transitory computer-readable storage medium storing a program to cause a computer to execute a control method of an information processing apparatus configured to offer at least a print function through execution of authentication in log-in operation, the control method comprising:
receiving an instruction for generating a pattern to be used in pattern authentication, the pattern authentication being one of ways of the authentication in the log-in operation;
generating the pattern;
storing the generated pattern; and
performing notification, wherein, in a case of a failure in the log-in operation, the generating of the pattern is redone, and, in the notification, information regarding a pattern generated again by redoing the generating is notified to a notification address corresponding to a user registered in the information processing apparatus.
